(19) United States
(12) Patent Application Publication
(10) Pub. No.: US 2026/0113262 A1
(43) Pub. Date: Apr. 23, 2026

(54) CHARGING CORRECTION METHOD AND APPARATUS, AND COMMUNICATION DEVICE AND STORAGE MEDIUM

(71) Applicant: Beijing Xiaomi Mobile Software Co., Ltd., Beijing (CN)

(72) Inventors: Jinhua WU, Beijing (CN); Yang SHEN, Beijing (CN); Jianning LIU, Beijing (CN); Yuxin MAO, Beijing (CN)

(73) Assignee: Beijing Xiaomi Mobile Software Co., Ltd., Beijing (CN)

(21) Appl. No.: 19/101,999

(22) PCT Filed: Aug. 9, 2022
(86) PCT No.: PCT/CN2022/111225

§ 371 Date: Feb. 7, 2025

(51) Int. Cl. H04L 43/0894; H04L 12/14; H04L 65/1069

(52) U.S. Cl. CPC H04L 43/0894; H04L 12/1403; H04L 65/1069

(57) ABSTRACT

A charging correction method, performed by a radio access network (RAN) entity, includes: sending usage data information for a charging correction to a network function, where the usage data information indicates packets dropped by the RAN entity in a packet data unit (PDU) set based quality of service (QoS) handling procedure, and where the network function is a first network function or a second network function.

### CROSS-REFERENCE TO RELATED APPLICATION

This application is the U.S. national phase application of International Application No. PCT/CN2022/111225, filed on Aug. 9, 2022, the disclosure of which is incorporated herein by reference in its entirety for all purposes.

### TECHNICAL FIELD

The present disclosure relates to, but is not limited to, the field of wireless communication technologies, and in particular, relates to a charging correction method and apparatus, a communication device and a storage medium.

### BACKGROUND

With the development of wireless networks, a quality of service (QoS) mechanism is being adopted in wireless communication systems. In an application scenario, service data streams have the characteristics of requiring high bandwidth, low latency and high reliability, so that the QoS requirements of data units and data sets of the data streams are expected to be matched to improve the user experience. The related technologies do not support a charging enhancement for the service data streams in this scenario. For example, a charging for downlink data is counted and reported and then, when matching data units in a data set with the QoS requirements of the data set, some remaining packets of the data set and/or some packets of one or more related data sets are to be actively dropped. However, actively dropping the charged packets will lead to inaccurate charging results.

### SUMMARY

Examples of the present disclosure disclose a charging correction method and apparatus, a communication device and a storage medium.

According to a first aspect of the examples of the present disclosure, a charging correction method is provided, which is performed by a radio access network (RAN) entity, and the method includes: sending usage data information for a charging correction to a network function, wherein the usage data information indicates packets dropped by the RAN entity in a packet data unit (PDU) set based quality of service (QoS) handling procedure, and wherein the network function is a first network function or a second network function.

According to a second aspect of the examples of the present disclosure, a charging correction method is provided, which is performed by a second network function, and the method includes: receiving usage data information for a charging correction sent by a RAN entity or a first network function, wherein the usage data information indicates packets dropped by the RAN entity in a PDU set based QoS handling procedure.

According to a third aspect of the examples of the present disclosure, a communication device is provided, which includes: one or more processors; and one or more memories for storing executable instructions for the one or more processors.

The one or more processors are configured to, by executing computer-executable instructions stored on the one or more memories, send usage data information for a charging correction to a network function, wherein the usage data information indicates packets dropped by the RAN entity in a packet data unit (PDU) set based quality of service (QoS) handling procedure, and wherein the network function is a first network function or a second network function.

In the examples of the present disclosure, the RAN entity sends the usage data information for the charging correction to the network function. The usage data information indicates the packets dropped by the RAN entity in the PDU set based QoS handling procedure. The network function is the first network function or the second network function. Since the RAN entity sends to the network function the usage data information indicating the packets dropped by the RAN entity in the PDU set based QoS handling procedure, the network function can perform the charging correction according to the usage data information after receiving the usage data information. Compared with a method where no charging correction is performed on the PDU set based charging, a charging accuracy can be improved.

### BRIEF DESCRIPTION OF THE DRAWINGS

FIG. 1 illustrates a schematic structural diagram of a wireless communication system according to an example.

FIG. 2 illustrates a schematic flowchart of a charging correction method according to an example.

FIG. 3 illustrates a schematic flowchart of a charging correction method according to an example.

FIG. 4 illustrates a schematic flowchart of a charging correction method according to an example.

FIG. 5 illustrates a schematic flowchart of a charging correction method according to an example.

FIG. 6 illustrates a schematic flowchart of a charging correction method according to an example.

FIG. 7 illustrates a schematic flowchart of a charging correction method according to an example.

FIG. 8 illustrates a schematic flowchart of a charging correction method according to an example.

FIG. 9 illustrates a schematic flowchart of a charging correction method according to an example.

FIG. 10 illustrates a schematic flowchart of a charging correction method according to an example.

FIG. 11 illustrates a schematic flowchart of a charging correction method according to an example.

FIG. 12 illustrates a schematic structural diagram of a charging correction apparatus according to an example.

FIG. 13 illustrates a schematic structural diagram of a charging correction apparatus according to an example.

FIG. 14 illustrates a schematic structural diagram of a charging correction apparatus according to an example.

FIG. 15 illustrates a schematic structural diagram of a charging correction apparatus according to an example.

FIG. 16 illustrates a schematic structural diagram of a terminal according to an example.

FIG. 17 illustrates a block diagram of a base station according to an example.

### DETAILED DESCRIPTION OF THE EMBODIMENTS

Examples will be described in detail here with the instances thereof illustrated in the drawings. Where the following descriptions involve the drawings, like numerals in different drawings refer to like or similar elements unless otherwise indicated. The implementations described in the following examples do not represent all implementations consistent with the examples of the present disclosure. Rather, they are merely instances of apparatuses and methods consistent with some aspects of the examples of the present disclosure as detailed in the appended claims.

The terms used in the examples of the present disclosure are for the purpose of describing particular examples only, and are not intended to limit the examples of the present disclosure. Terms determined by “a” and “the” in their singular forms used in the examples of the present disclosure and the appended claims are also intended to include their plural forms, unless clearly indicated otherwise in the context. It is also to be understood that the term “and/or” as used herein is and includes any and all possible combinations of one or more of the associated listed items.

It is to be understood that, although terms “first,” “second,” “third,” and the like may be adopted in the examples of the present disclosure to describe various information, such information should not be limited to these terms. These terms are only used to distinguish the information of the same type with each other. For example, without departing from the scope of the examples of the present disclosure, first information may be referred to as second information; and similarly, second information may also be referred to as first information. Depending on the context, the word “if”′ as used herein may be interpreted as “when,” “upon,” or “in response to determining.”

For brevity and for convenience of understanding, the term “greater than” or “less than” is used herein when a size relationship is presented. However, it is to be understood by those skilled in the art that the term “greater than” also covers the meaning of “greater than or equal to”, and the term “less than” also covers the meaning of “less than or equal to.”

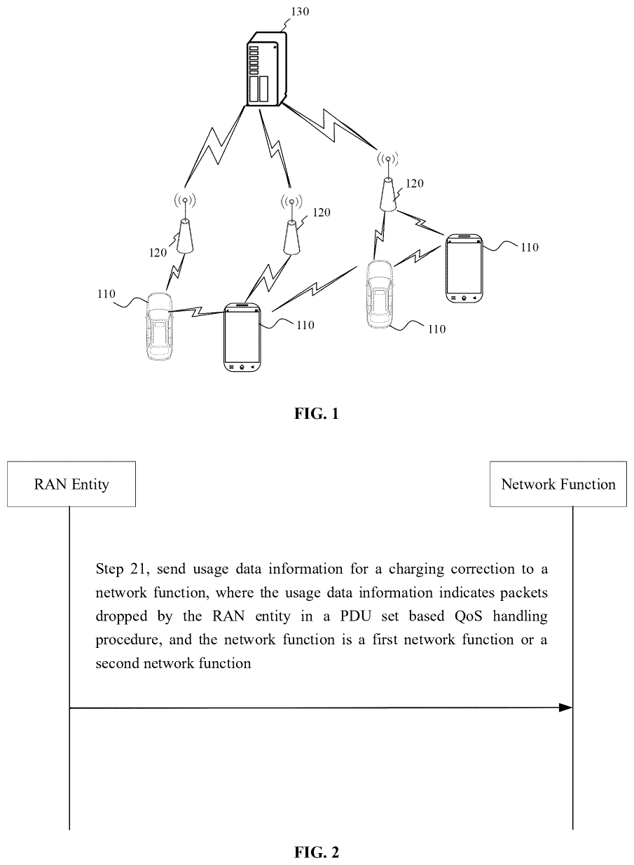

Please refer to FIG. 1, which illustrates a schematic structural diagram of a wireless communication system provided in an example of the present disclosure. As illustrated in FIG. 1, the wireless communication system is a communication system based on mobile communication technologies, and may include several user equipment (UE) 110 and several base stations 120.

The UE 110 may refer to a device that provides voice and/or data connectivity for a user. The UE 110 may communicate with one or more core networks via a radio access network (RAN). The UE 110 may be Internet of Things (IOT) UE, such as a sensor device, a mobile phone and a computer with IoT UE. For example, it may be a fixed, portable, pocket-sized, handheld, computer-built-in, or vehicle-mounted device, such as a station (STA), a subscriber unit, a subscriber station, a mobile station, a mobile, a remote station, an access point, a remote terminal, an access terminal, a user terminal, a user agent, a user device, or UE. Or, the UE 110 may be a device such as an unmanned aerial vehicle. Or, the UE 110 may be a vehicle-mounted device. For example, it may be an on-board computer with a wireless communication function, or wireless UE externally connected to the on-board computer. Or, the UE 110 may be a roadside device, for example, a street lamp, a signal lamp or another roadside device with a wireless communication function.

The base station 120 may be a network side device in the wireless communication system. The wireless communication system may be a 4th generation (4G) mobile communication system, which is also known as a long term evolution (LTE) system. Or, the wireless communication system may be a 5th generation (5G) system, which is also known as a new radio (NR) system or a 5G NR system. Or, the wireless communication system may be a next-generation system of the 5G system. An access network in the 5G system may be called a new generation-radio access network (NG-RAN).

The base station 120 may be an evolved Node-B (eNB) adopted in the 4G system. Alternatively, the base station 120 may be a base station (a next generation Node-B (gNB)) with a centralized and distributed architecture in the 5G system. With the centralized and distributed architecture, the base station 120 usually includes a central unit (CU) and at least two distributed units (DU). The CU is equipped with protocol stacks of a packet data convergence protocol (PDCP) layer, a radio link control (RLC) protocol layer, and a media access control (MAC) layer. The DU is equipped with protocol stacks of a physical (PHY) layer. The examples of the present disclosure do not limit the specific implementations of the base station 120.

A wireless connection may be established between the base station 120 and the UE 110 through a wireless air interface. In different implementations, the wireless air interface is a wireless air interface based on 4G mobile communication network technology standards, a wireless air interface based on 5G mobile communication network technology standards such as a new radio interface, or a wireless air interface based on next-generation mobile communication network technology standards of the 5G.

In some examples, an end-to-end (E2E) connection may be established between UE 110, for example, in a scenario of a vehicle-to-everything (V2X) communication such as a vehicle-to-vehicle (V2V) communication, a vehicle-to-infrastructure (V2I) communication or a vehicle-to-pedestrian (V2P) communication.

In the present disclosure, the UE may be regarded as a terminal device in the following examples.

In some examples, the wireless communication system may further include a network management device 130.

The several base stations 120 are connected to the network management device 130, respectively. The network management device 130 may be an access and mobility management function (AMF), a session management function (SMF), a user plane function (UPF), a policy control function (PCF), a network repository function (NRF), etc. The implemented forms of the network management device 130 are not limited by the examples of the present disclosure.

In order to facilitate understanding by those skilled in the art, the examples of the present disclosure list multiple implementations to clearly describe the technical solutions of the examples of the present disclosure. Of course, those skilled in the art may understand that the multiple examples provided in the present disclosure may be performed individually, performed by combining with one or more methods in other examples of the present disclosure, or performed, alone or after the combination, together with some methods in other related technologies, which is not limited by the examples of the present disclosure.

In order to better understand the technical solution described in any example of the present disclosure, an application scenario of the related technologies is first described.

Mobile media services, extended reality (XR) services such as cloud augmented reality (AR) services or virtual reality (VR) services, cloud games, video-based machines, drone remote control services, etc., are expected to contribute increasing traffic to 5G networks.

Besides audio streams and video streams, the XR services also involve multimodal data streams, for example, biotouch sensing data streams. These multimodal data are data inputted from the same device or different devices (including one or more sensors) for describing the same service or application. These data may be outputted to one or more terminals as destination devices. The various data streams of the multimodal data often have certain or even strong correlations, for example, a synchronization between the audio streams and the video streams and a synchronization between touch and vision. For the data streams of these types of media services, there are some common characteristics presented in themselves, between them, and in the network transmission requirements of them. Effective identification and exploitation of these characteristics will be more conducive to network and service transmission and control, and also more conducive to service assurance and user experience.

However, a general-purpose quality of service (QoS) mechanism is adopted in the 5G systems to handle various data services including the XR services, without fully considering the characteristics of the XR media services. Therefore, differentiated uplink and downlink requirements, such as asymmetric requirements in uplink data reliability and downlink data bandwidth, cannot be effectively supported. Meanwhile, the XR media data streams have the characteristics of requiring high bandwidth, low latency and high reliability, so that the QoS requirements of data units and data sets within the data streams, such as dependencies between the data units in the data sets, dependencies between the data sets, importances (priorities) of the data units in the data sets, and importances (priorities) of the data sets, are expected to be further matched to effectively improve the user experience.

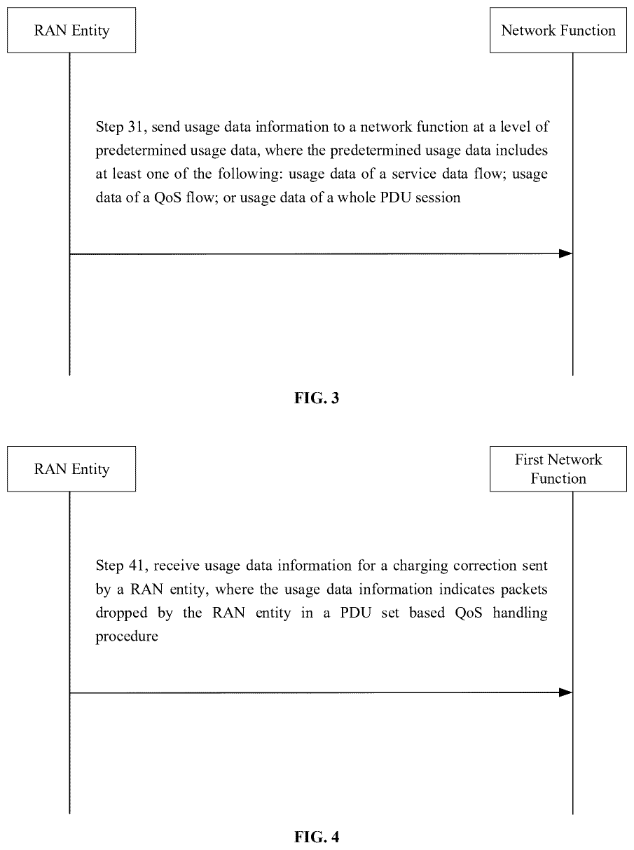

As illustrated in FIG. 2, the example provides a charging correction method, which is performed by a radio access network (RAN) entity. The method includes the following step.

At step 21, usage data information for a charging correction is sent to a network function.

The usage data information indicates packets dropped by the RAN entity in a packet data unit (PDU) set based QoS handling procedure, and the network function is a first network function or a second network function.

The network function involved in the present disclosure may be a device in a core network. For example, the first network function is a UPF, and the second network function is an SMF.

The RAN entity involved in the present disclosure may be a base station. The base station may be a base station of various types, for example, a base station of a third generation mobile communication (3G) network, a base station of a 4G network, a base station of a 5G network, or another evolved base station.

In an example, the usage data information for the charging correction on a scheduled service is sent to the network function, the usage data information indicates the packets dropped by the RAN entity in the PDU set based QoS handling procedure, and the network function is the first network function or the second network function.

In an example, the scheduled service includes at least one of the following: an extended reality and media (XRM) service; or
a multimodal service.

However, it is to be noted that the scheduled service is not limited to the XRM service and/or the multimodal service, but may also be various general services or basic services such as a terminal service, which is not limited here.

In an example, the usage data information for the charging correction is sent to the second network function via the first network function, and the usage data information indicates the packets dropped by the RAN entity in the PDU set based QoS handling procedure. Sending the usage data information to the second network function via the first network function may include: sending the usage data information to the first network function first, and then sending the usage data information from the first network function to the second network function.

In an example, it is determined that the RAN entity supports the charging correction. the usage data information for the charging correction is sent to the network function. The usage data information indicates the packets dropped by the RAN entity in the PDU set based QoS handling procedure. The network function is the first network function or the second network function. For example, according to received indication information, whether the RAN entity supports the charging correction may be determined. The received indication information may be sent by a PCF.

In an example, the usage data information for the charging correction is sent to the network function in the PDU set based QoS handling procedure. The usage data information indicates the packets dropped by the RAN entity in the PDU set based QoS handling procedure. The network function is the first network function or the second network function.

In an example, the usage data information is sent to the network function at a level of predetermined usage data. The usage data information indicates the packets dropped by the RAN entity in the PDU set based QoS handling procedure. The predetermined usage data includes at least one of the following: usage data of a service data flow; usage data of a QoS flow; or usage data of a whole PDU session. The network function is the first network function or the second network function.

In an example, the usage data information is collected at the level of predetermined usage data. The usage data information indicates the packets dropped by the RAN entity in the PDU set based QoS handling procedure. The predetermined usage data includes at least one of the following: the usage data of a service data flow; the usage data of a QoS flow; or the usage data of a whole PDU session. The usage data information is sent to the network function at the level of predetermined usage data. The network function is the first network function or the second network function.

In an example, the usage data information is collected based on a monitoring key. The usage data information for the charging correction is sent to the network function. The usage data information indicates the packets dropped by the RAN entity in the PDU set based QoS handling procedure. The network function is the first network function or the second network function. In an example, a PDU set is determined to be dropped in a case of a PDU set delay budget (PSDB) being exceeded, a PDU set error rate being exceeded, a delivery failure of one or more dependent PDU sets, or a delivery failure of one or more important PDU sets. A packet of the PDU set is determined to be dropped in a case of a packet error rate being exceeded, a delivery failure of one or more dependent packets of the PDU set, a delivery failure of one or more important packets of the PDU set, or a packet delay budget being exceeded. In response to determining that the PDU set or the packet of the PDU set is dropped, the usage data information for the charging correction is sent to the network function. The usage data information indicates the packets dropped by the RAN entity in the PDU set based QoS handling procedure. The network function is the first network function or the second network function.

In an example, the usage data information for the charging correction is sent to the network function. The usage data information indicates the packets dropped by the RAN entity in the PDU set based QoS handling procedure. The network function is the first network function or the second network function. A charging scheme of a PDU set based charging includes one of the following: a usage charging scheme; a usage-duration combined charging scheme; a usage-event combined charging scheme; or a usage-duration-event combined charging scheme.

In an example, the usage data information for the charging correction is sent to the network function. The usage data information indicates the packets dropped by the RAN entity in the PDU set based QoS handling procedure. The network function is the first network function or the second network function. A charging approach of the PDU set based charging includes one of the following: an online charging approach; an offline charging approach; or a hybrid online and offline charging approach.

In the examples of the present disclosure, the RAN entity sends the usage data information for the charging correction to the network function. The usage data information indicates the packets dropped by the RAN entity in the PDU set based QoS handling procedure. The network function is the first network function or the second network function. Since the RAN entity sends to the network function the usage data information that indicates the packets dropped by the RAN entity in the PDU set based QoS handling procedure, the network function can perform the charging correction according to the usage data information after receiving the usage data information. Compared with a method where no charging correction is performed on the PDU set based charging, a charging accuracy can be improved.

It is to be noted that those skilled in the art can understand that the method provided in the examples of the present disclosure may be performed alone or together with some methods in the examples of the present disclosure or some methods in related technologies.

As illustrated in FIG. 3, the example provides a charging correction method, which is performed by a RAN entity. The method includes the following step.

At step 31, usage data information is sent to a network function at a level of predetermined usage data, where the predetermined usage data includes at least one of the following:
usage data of a service data flow;
usage data of a QoS flow; or
usage data of a whole PDU session.

In an example, the usage data information is sent to the network function at the level of predetermined usage data. The usage data information indicates packets dropped by the RAN entity in a PDU set based QoS handling procedure. The predetermined usage data includes at least one of the following: the usage data of the service data flow; the usage data of the QoS flow; or the usage data of the whole PDU session. The network function is the first network function or the second network function.

In an example, the usage data information is collected at the level of predetermined usage data. The usage data information indicates the packets dropped by the RAN entity in the PDU set based QoS handling procedure. The predetermined usage data includes at least one of the following: the usage data of the service data flow; the usage data of the QoS flow; or the usage data of the whole PDU session. The usage data information is sent to the network function at the level of predetermined usage data. The network function is the first network function or the second network function.

It is to be noted that those skilled in the art can understand that the method provided in the examples of the present disclosure may be performed alone or together with some methods in the examples of the present disclosure or some methods in related technologies.

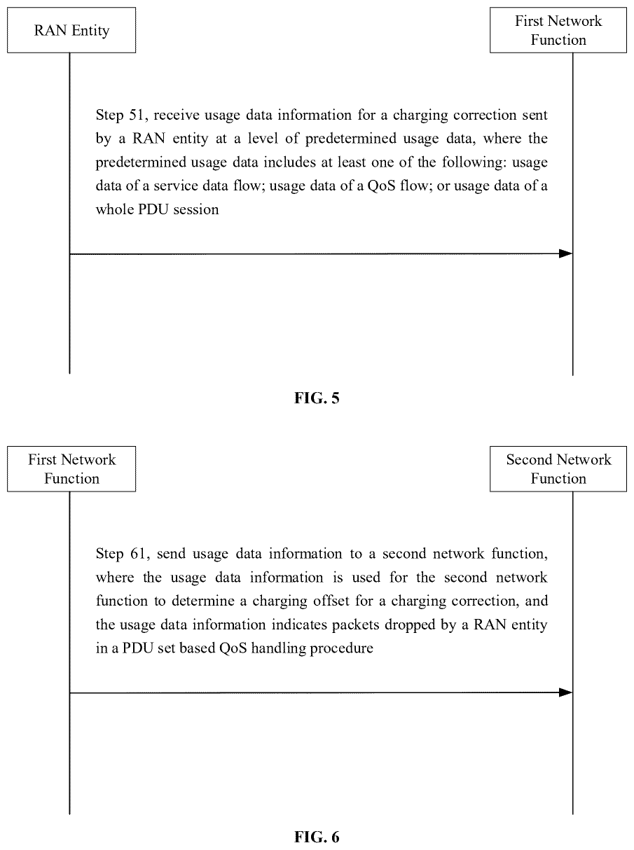

As illustrated in FIG. 4, the example provides a charging correction method, which is performed by a first network function. The method includes the following step.

At step 41, usage data information for a charging correction sent by a RAN entity is received.

The usage data information indicates packets dropped by the RAN entity in a PDU set based QoS handling procedure.

The network function involved in the present disclosure may be a device in a core network. For example, the first network function is a UPF, and a second network function is an SMF.

The RAN entity involved in the present disclosure may be a base station. The base station may be a base station of various types, for example, a base station of a 3G network, a base station of a 4G network, a base station of a 5G network, or another evolved base station.

In an example, the usage data information for the charging correction on a scheduled service sent by the RAN entity is received, and the usage data information indicates the packets dropped by the RAN entity in the PDU set based QoS handling procedure.

In an example, the scheduled service includes at least one of the following:
an XRM service; or
a multimodal service.

However, it is to be noted that the scheduled service is not limited to the XRM service and/or the multimodal service, but may also be various general services or basic services such as a terminal service, which is not limited here.

In an example, the usage data information for the charging correction sent by the RAN entity is received, where the usage data information indicates the packets dropped by the RAN entity in the PDU set based QoS handling procedure, and the usage data information is sent to and is used by the second network function to determine a charging offset for the charging correction.

In an example, the usage data information for the charging correction sent by the RAN entity is received in the PDU set based QoS handling procedure. The usage data information indicates the packets dropped by the RAN entity in the PDU set based QoS handling procedure.

In an example, the usage data information sent by the RAN entity is received at a level of predetermined usage data. The usage data information indicates the packets dropped by the RAN entity in the PDU set based QoS handling procedure. The predetermined usage data includes at least one of the following: usage data of a service data flow; usage data of a QoS flow; or usage data of a whole PDU session.

In an example, a PDU set is determined to be dropped in a case of a PSDB being exceeded, a PDU set error rate being exceeded, a delivery failure of one or more dependent PDU sets, or a delivery failure of one or more important PDU sets. A packet of the PDU set is determined to be dropped in a case of a packet error rate being exceeded, a delivery failure of one or more dependent packets of the PDU set, a delivery failure of one or more important packets of the PDU set, or a packet delay budget being exceeded. In response to determining that the PDU set or the packet of the PDU set is dropped, the usage data information for the charging correction sent by the RAN entity is received. The usage data information indicates the packets dropped by the RAN entity in the PDU set based QoS handling procedure.

In an example, the usage data information for the charging correction sent by the RAN entity is received. The usage data information indicates the packets dropped by the RAN entity in the PDU set based QoS handling procedure. A charging scheme of a PDU set based charging includes one of the following: a usage charging scheme; a usage-duration combined charging scheme; a usage-event combined charging scheme; or a usage-duration-event combined charging scheme.

In an example, the usage data information for the charging correction sent by the RAN entity is received. The usage data information indicates the packets dropped by the RAN entity in the PDU set based QoS handling procedure. A charging approach of the PDU set based charging includes one of the following: an online charging approach; an offline charging approach; or a hybrid online and offline charging approach.

It is to be noted that those skilled in the art can understand that the method provided in the examples of the present disclosure may be performed alone or together with some methods in the examples of the present disclosure or some methods in related technologies.

As illustrated in FIG. 5, the example provides a charging correction method, which is performed by a first network function. The method includes the following step.

At step 51, usage data information for a charging correction sent by a RAN entity is received at a level of predetermined usage data, where the predetermined usage data includes at least one of the following:
usage data of a service data flow; usage data of a QoS flow; or
usage data of a whole PDU session.

In an example, the usage data information sent by the RAN entity is received at the level of predetermined usage data. The usage data information indicates packets dropped by the RAN entity in a PDU set based QoS handling procedure. The predetermined usage data includes at least one of the following: the usage data of the service data flow; the usage data of the QoS flow; or the usage data of the whole PDU session.

It is to be noted that those skilled in the art can understand that the method provided in the examples of the present disclosure may be performed alone or together with some methods in the examples of the present disclosure or some methods in related technologies.

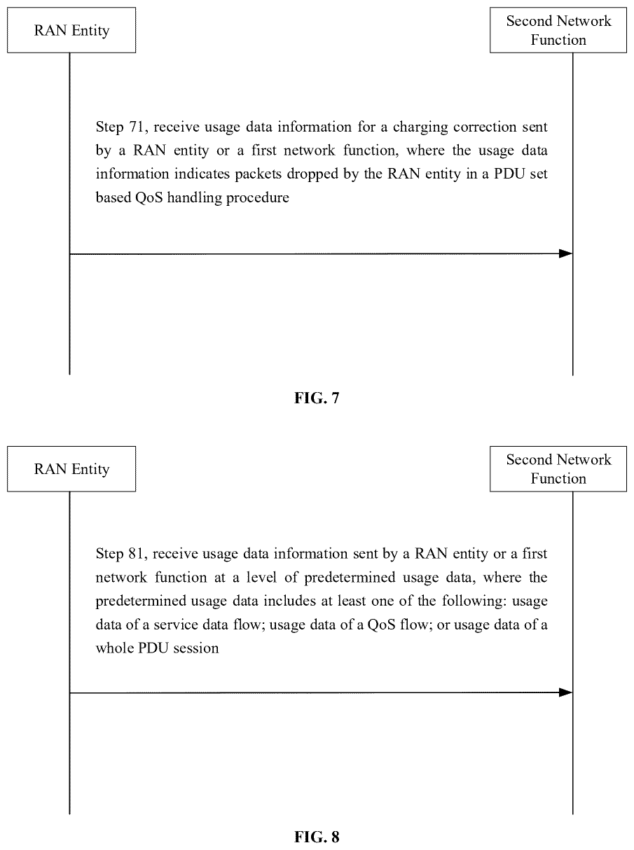

As illustrated in FIG. 6, the example provides a charging correction method, which is performed by a first network function. The method includes the following step.

At step 61, usage data information is sent to a second network function.

The usage data information is used for the second network function to determine a charging offset for a charging correction, and the usage data information indicates packets dropped by a RAN entity in a PDU set based QoS handling procedure.

In an example, the usage data information for the charging correction sent by the RAN entity is received in response to determining that the second network function is a subject that performs a charging function. The usage data information indicates the packets dropped by the RAN entity in the PDU set based QoS handling procedure. The usage data information is sent to and is used by the second network function to determine the charging offset for the charging correction.

It is to be noted that those skilled in the art can understand that the method provided in the examples of the present disclosure may be performed alone or together with some methods in the examples of the present disclosure or some methods in related technologies.

As illustrated in FIG. 7, the example provides a charging correction method, which is performed by a second network function. The method includes the following step.

At step 71, usage data information for a charging correction sent by a RAN entity or a first network function is received.

The usage data information indicates packets dropped by the RAN entity in a PDU set based QoS handling procedure.

The network function involved in the present disclosure may be a device in a core network. For example, the first network function is a UPF, and a second network function is an SMF.

The RAN entity involved in the present disclosure may be a base station. The base station may be a base station of various types, for example, a base station of a 3G network, a base station of a 4G network, a base station of a 5G network, or another evolved base station.

In an example, the usage data information for the charging correction on a scheduled service sent by the RAN entity or the first network function is received, and the usage data information indicates the packets dropped by the RAN entity in the PDU set based QoS handling procedure.

In an example, the scheduled service includes at least one of the following:
an XRM service; or
a multimodal service.

However, it is to be noted that the scheduled service is not limited to the XRM service and/or the multimodal service, but may also be various general services or basic services such as a terminal service, which is not limited here.

In an example, the usage data information for the charging correction sent by the RAN entity is received via the first network function, and the usage data information indicates the packets dropped by the RAN entity in the PDU set based QoS handling procedure. Receiving the usage data information sent by the RAN entity via the first network function may include that the RAN entity sends the usage data information to the first network function first, and then the first network function sends the usage data information to the second network function.

In an example, the usage data information for the charging correction sent by the RAN entity or the first network function is received in the PDU set based QoS handling procedure. The usage data information indicates the packets dropped by the RAN entity in the PDU set based QoS handling procedure.

In an example, the usage data information sent by the RAN entity or the first network function is received at a level of predetermined usage data. The usage data information indicates the packets dropped by the RAN entity in the PDU set based QoS handling procedure. The predetermined usage data includes at least one of the following: usage data of a service data flow; usage data of a QoS flow; or usage data of a whole PDU session.

In an example, a PDU set is determined to be dropped in a case of a PSDB being exceeded, a PDU set error rate being exceeded, a delivery failure of one or more dependent PDU sets, or a delivery failure of one or more important PDU sets. A packet of the PDU set is determined to be dropped in a case of a packet error rate being exceeded, a delivery failure of one or more dependent packets of the PDU set, a delivery failure of one or more important packets of the PDU set, or a packet delay budget being exceeded. In response to determining that the PDU set or the packet of the PDU set is dropped, the usage data information for the charging correction sent by the RAN entity or the first network function is received. The usage data information indicates the packets dropped by the RAN entity in the PDU set based QoS handling procedure.

In an example, the usage data information for the charging correction sent by the RAN entity or the first network function is received. The usage data information indicates the packets dropped by the RAN entity in the PDU set based QoS handling procedure. A charging scheme of a PDU set based charging includes one of the following: a usage charging scheme; a usage-duration combined charging scheme; a usage-event combined charging scheme; or a usage-duration-event combined charging scheme.

In an example, the usage data information for the charging correction sent by the RAN entity or the first network function is received. The usage data information indicates the packets dropped by the RAN entity in the PDU set based QoS handling procedure. A charging approach of the PDU set based charging includes one of the following: an online charging approach; an offline charging approach; or a hybrid online and offline charging approach.

In an example, the usage data information for the charging correction sent by the RAN entity or the first network function is received. The usage data information indicates the packets dropped by the RAN entity in the PDU set based QoS handling procedure. A charging offset for the charging correction is determined according to the usage data information.

In an example, the usage data information for the charging correction sent by the RAN entity or the first network function is received. The usage data information indicates the packets dropped by the RAN entity in the PDU set based QoS handling procedure. The charging offset for the charging correction is determined according to the usage data information. Corrected usage data is obtained by correcting usage data to be charged according to the charging offset.

In an example, the usage data information for the charging correction sent by the RAN entity or the first network function is received. The usage data information indicates the packets dropped by the RAN entity in the PDU set based QoS handling procedure. The charging offset for the charging correction is determined according to the usage data information. The corrected usage data is obtained by correcting the usage data to be charged according to the charging offset. Information on the corrected usage data is sent to a a charging function (CHF).

It is to be noted that those skilled in the art can understand that the method provided in the examples of the present disclosure may be performed alone or together with some methods in the examples of the present disclosure or some methods in related technologies.

As illustrated in FIG. 8, the example provides a charging correction method, which is performed by a second network function. The method includes the following step.

At step 81, usage data information sent by a RAN entity or a first network function is received at a level of predetermined usage data, where the predetermined usage data includes at least one of the following:
usage data of a service data flow; usage data of a QoS flow; or
usage data of a whole PDU session.

In an example, the usage data information sent by the RAN entity or the first network function is received at the level of predetermined usage data. The usage data information indicates packets dropped by the RAN entity in a PDU set based QoS handling procedure. The predetermined usage data includes at least one of the following: the usage data of the service data flow; the usage data of the QoS flow; or the usage data of the whole PDU session.

It is to be noted that those skilled in the art can understand that the method provided in the examples of the present disclosure may be performed alone or together with some methods in the examples of the present disclosure or some methods in related technologies.

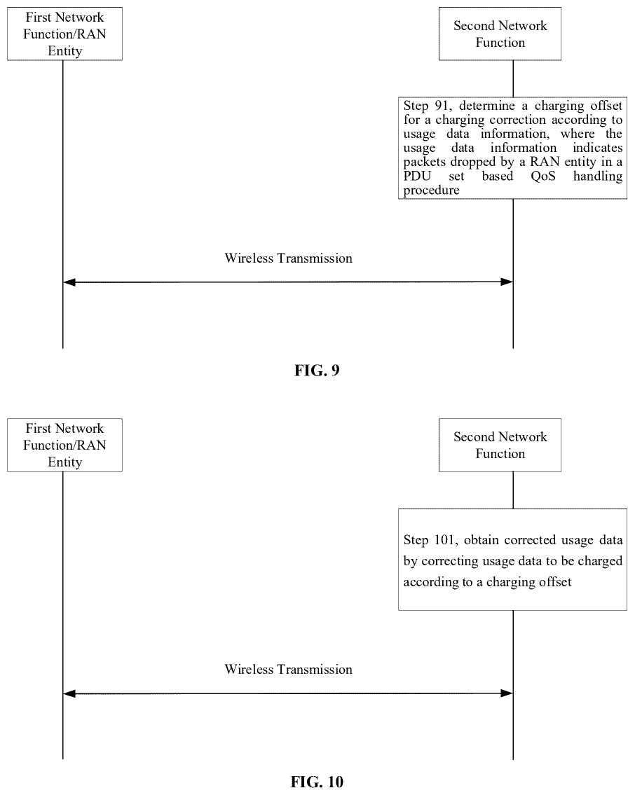

As illustrated in FIG. 9, the example provides a charging correction method, which is performed by a second network function. The method includes the following step.

At step 91, a charging offset for a charging correction is determined according to usage data information,
where the usage data information indicates packets dropped by a RAN entity in a PDU set based QoS handling procedure.

In an example, the usage data information for the charging correction sent by the RAN entity or a first network function is received. The usage data information indicates the packets dropped by the RAN entity in the PDU set based QoS handling procedure. The charging offset for the charging correction is determined according to the usage data information.

In an example, the usage data information for the charging correction sent by the RAN entity or the first network function is received. The usage data information indicates the packets dropped by the RAN entity in the PDU set based QoS handling procedure. The charging offset for the charging correction is determined according to the usage data information. Corrected usage data is obtained by correcting usage data to be charged according to the charging offset.

It is to be noted that those skilled in the art can understand that the method provided in the examples of the present disclosure may be performed alone or together with some methods in the examples of the present disclosure or some methods in related technologies.

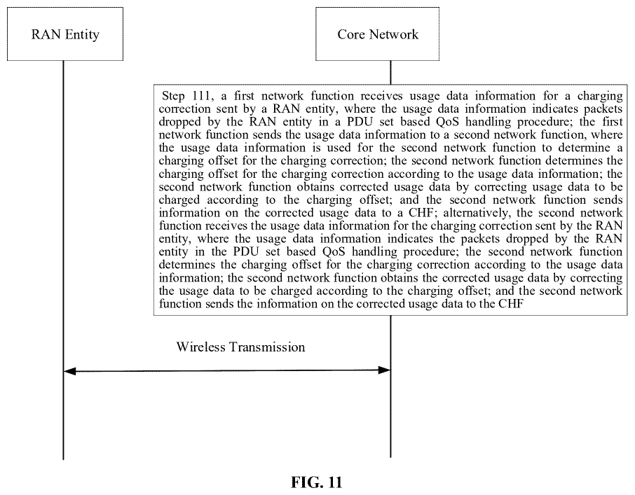

As illustrated in FIG. 10, the example provides a charging correction method, which is performed by a second network function. The method includes the following step.

At step 101, corrected usage data is obtained by correcting usage data to be charged according to a charging offset.

In an example, usage data information for a charging correction sent by a RAN entity or a first network function is received. The usage data information indicates packets dropped by the RAN entity in a PDU set based QoS handling procedure. The charging offset for the charging correction is determined according to the usage data information. The corrected usage data is obtained by correcting the usage data to be charged according to the charging offset. Information on the corrected usage data is sent to a CHF.

It is to be noted that those skilled in the art can understand that the method provided in the examples of the present disclosure may be performed alone or together with some methods in the examples of the present disclosure or some methods in related technologies.

As illustrated in FIG. 11, the example provides a charging correction method, which is performed by a core network. The method includes the following step.

At step 111, a second network function receives usage data information for a charging correction sent by a RAN entity or forwarded by a first network function, where the usage data information indicates packets dropped by the RAN entity in a PDU set based QoS handling procedure; the second network function determines a charging offset for the charging correction according to the usage data information; the second network function obtains corrected usage data by correcting usage data to be charged according to the charging offset; and the second network function sends information on the corrected usage data to a CHF.

The network function involved in the present disclosure may be a device in a core network. For example, the first network function is a UPF, and the second network function is an SMF.

The RAN entity involved in the present disclosure may be a base station. The base station may be a base station of various types, for example, a base station of a 3G network, a base station of a 4G network, a base station of a 5G network, or another evolved base station.

In an example, the usage data information for the charging correction on a scheduled service sent by the RAN entity or the first network function is received, and the usage data information indicates the packets dropped by the RAN entity in the PDU set based QoS handling procedure.

In an example, the scheduled service includes at least one of the following:
an XRM service; or
a multimodal service.

However, it is to be noted that the scheduled service is not limited to the XRM service and/or the multimodal service, but may also be various general services or basic services such as a terminal service, which is not limited here.

It is to be noted that those skilled in the art can understand that the method provided in the examples of the present disclosure may be performed alone or together with some methods in the examples of the present disclosure or some methods in related technologies.

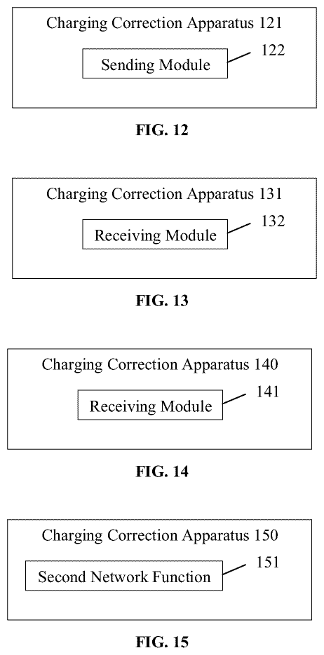

As illustrated in FIG. 12, the example provides a charging correction apparatus 121. The apparatus 121 includes:
a sending module 122 that is configured to send usage data information for a charging correction to a network function.

The usage data information indicates packets dropped by a RAN entity in a PDU set based QoS handling procedure. The network function is a first network function or a second network function.

It is to be noted that those skilled in the art can understand that the apparatus 121 provided in the examples of the present disclosure may be employed alone or together with some apparatuses in the examples of the present disclosure or some apparatuses in related technologies.

As illustrated in FIG. 13, the example provides a charging correction apparatus 131. The apparatus 131 includes:
a receiving module 132 that is configured to receive usage data information for a charging correction sent by a RAN entity.

The usage data information indicates packets dropped by the RAN entity in a PDU set based QoS handling procedure.

It is to be noted that those skilled in the art can understand that the apparatus 131 provided in the examples of the present disclosure may be employed alone or together with some apparatuses in the examples of the present disclosure or some apparatuses in related technologies.

As illustrated in FIG. 14, the example provides a charging correction apparatus 140. The apparatus 140 includes:
a receiving module 141 that is configured to receive usage data information for a charging correction sent by a RAN entity or a first network function.

The usage data information indicates packets dropped by the RAN entity in a PDU set based QoS handling procedure.

It is to be noted that those skilled in the art can understand that the apparatus 140 provided in the examples of the present disclosure may be employed alone or together with some apparatuses in the examples of the present disclosure or some apparatuses in related technologies.

As illustrated in FIG. 15, the example provides a charging correction apparatus 150. The apparatus 150 includes:
a second network function 151, where the second network function is configured to receive usage data information for a charging correction sent by a RAN entity or forwarded by a first network function, in which the usage data information indicates packets dropped by the RAN entity in a PDU set based QoS handling procedure; the second network function is configured to determine a charging offset for the charging correction according to the usage data information; the second network function is configured to obtain corrected usage data by correcting usage data to be charged according to the charging offset; and the second network function is configured to send information on the corrected usage data to a CHF.

It is to be noted that those skilled in the art can understand that the apparatus 150 provided in the examples of the present disclosure may be employed alone or together with some apparatuses in the examples of the present disclosure or some apparatuses in related technologies.

An example of the present disclosure provides a communication device. The communication device includes:
one or more processors; and
one or more memories for storing executable instructions for the one or more processors.

The one or more processors are configured to implement, when running the executable instructions, the method applied to any example of the present disclosure.

The memory may include a storage medium of various types. The storage medium is a non-transitory computer storage medium capable of continuously storing information thereon after the communication device is powered down.

The one or more processors may be coupled to the one or more memories through a bus or the like, and are configured to read an executable program stored on the one or more memories.

An example of the present disclosure also provides a computer storage medium storing a computer executable program. The executable program, when being executed by one or more processors, implements the method according to any example of the present disclosure.

With respect to the apparatus in the foregoing examples, the specific manners in which each module performs its operation has been described in detail in the examples of the related methods, and will not be further described in detail here.

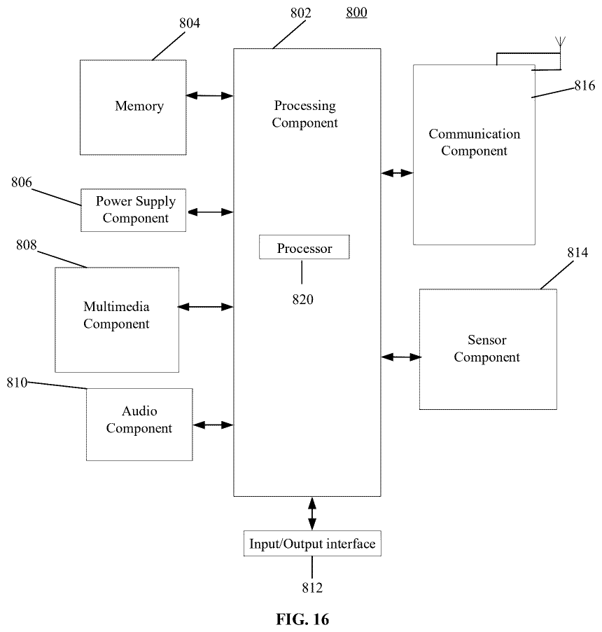

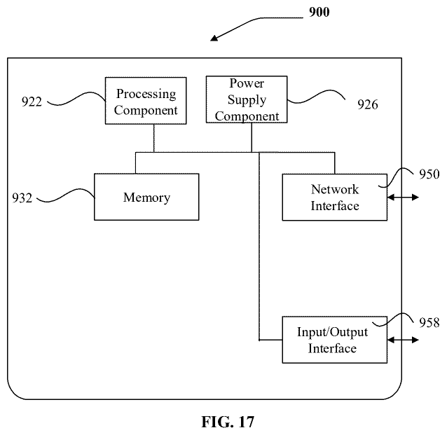

As illustrated in FIG. 16, an example of the present disclosure provides a structure of a terminal.

Referring to FIG. 16 which illustrates a terminal 800. The terminal 800 is provided in the example of the present disclosure. The terminal may specifically be a mobile phone, a computer, a digital broadcast terminal, a message transceiver, a game console, a tablet device, a medical device, a fitness device, a personal digital assistant, etc.

Referring to FIG. 16, the terminal 800 may include one or more of the following components: a processing component 802, a memory 804, a power supply component 806, a multimedia component 808, an audio component 810, an input/output (I/O) interface 812, a sensor component 814, and a communication component 816.

The processing component 802 generally controls the overall operations of the terminal 800, such as operations associated with display, phone calls, data communications, camera operations, and recording operations. The processing component 802 may include one or more processors 820 to execute instructions to complete all or a part of the steps of the foregoing methods. In addition, the processing component 802 may include one or more modules which facilitate the interaction between the processing component 802 and other components. For example, the processing component 802 may include a multimedia module to facilitate the interaction between the multimedia component 808 and the processing component 802.

The memory 804 is configured to store various types of data to support the operations of the terminal 800. Examples of such data include instructions for any application or method operated on the terminal 800, contact data, phonebook data, messages, pictures, videos, and the like. The memory 804 may be implemented by any type of volatile or non-volatile storage device or a combination thereof, such as a static random access memory (SRAM), an electrically erasable programmable read-only memory (EEPROM), an erasable and programmable read-only memory (EPROM), a programmable read-only memory (PROM), a read-only memory (ROM), a magnetic memory, a flash memory, a magnetic disk or an optical disk.

The power supply component 806 provides power for various components of the terminal 800. The power supply component 806 may include a power management system, one or more power supplies, and other components associated with generating, managing, and distributing power for the terminal 800.

The multimedia component 808 includes a screen providing an output interface between the terminal 800 and a user. In some examples, the screen may include a liquid crystal display (LCD) and a touch panel (TP). If the screen includes the TP, the screen may be implemented as a touch screen to receive input signals from the user. The TP may include one or more touch sensors to sense touches, swipes, and gestures on the TP. The touch sensors may not only sense a boundary of a touch or swipe, but also sense a lasting time and a pressure associated with the touch or swipe. In some examples, the multimedia component 808 includes a front camera and/or a rear camera. The front camera and/or rear camera may receive external multimedia data when the terminal 800 is in an operating mode, such as a photographing mode or a video mode. Each front camera and rear camera may be a fixed optical lens system or have focal length and optical zooming capability.

The audio component 810 is configured to output and/or input audio signals. For example, the audio component 810 includes a microphone (MIC) that is configured to receive external audio signal when the terminal 800 is in an operating mode, such as a call mode, a recording mode, and a voice recognition mode. The received audio signals may be further stored in memory 804 or transmitted via communication component 816. In some examples, the audio component 810 also includes a speaker for outputting audio signals.

The I/O interface 812 provides an interface between the processing component 802 and a peripheral interface module. The peripheral interface module may be a keyboard, a click wheel, buttons, or the like. These buttons may include but not limited to a home button, a volume button, a start button and a lock button.

The sensor component 814 includes one or more sensors to provide the terminal 800 with state assessments in various aspects. For example, the sensor component 814 may detect an open/closed state of the terminal 800 and a relative positioning of components such as the display and keypad of the terminal 800, and the sensor component 814 may also detect a change in position of the terminal 800 or a component of the terminal 800, the presence or absence of user contact between a user and the terminal 800, orientation or acceleration/deceleration of the terminal 800, and temperature change of the terminal 800. The sensor component 814 may include a proximity sensor configured to detect the presence of a nearby object without any physical contact. The sensor component 814 may also include a light sensor, such as a complementary metal oxide semiconductor (CMOS) or charge-coupled device (CCD) image sensor, for being applied in imaging applications. In some examples, the sensor component 814 may also include an acceleration sensor, a gyro sensor, a magnetic sensor, a pressure sensor, or a temperature sensor.

The communication component 816 is configured to facilitate wired or wireless communication between the terminal 800 and other devices. The terminal 800 may access a wireless network based on a communication standard, such as WiFi, 2G, 3G, 4G, 5G, 6G or a combination thereof. In an example, the communication component 816 receives broadcast signals or broadcast related information from an external broadcast management system via a broadcast channel. In an example, the communication component 816 also includes a near field communication (NFC) module to facilitate short-range communication. For example, the NFC module may be implemented based on a radio frequency identification (RFID) technology, an infrared data association (IrDA) technology, an ultra-wideband (UWB) technology, a Bluetooth® (BT) technology and other technologies.

In one or more examples, the terminal 800 may be implemented by one or more application specific integrated circuits (ASICs), digital signal processors (DSPs), digital signal processing equipment (DSPD), programmable logic devices (PLDs), field programmable gate arrays (FPGAs), controllers, microcontrollers, microprocessors, or other electronics to perform the foregoing methods.

In one or more examples, a non-transitory computer-readable storage medium including instructions is provided, such as the memory 804 including instructions. These instructions may be executed by the one or more processors 820 of the terminal 800 to complete the foregoing methods. For example, the non-transitory computer-readable storage medium may be an ROM, a random access memory (RAM), a CD-ROM, a magnetic tape, a floppy disk, an optical data storage device, and the like.

As illustrated in FIG. 17, an example of the present disclosure illustrates a structure of a base station. For example, the base station 900 may be provided as a network-side device. Referring to FIG. 17, the base station 900 includes a processing component 922 which further includes one or more processors, and a memory resource represented by a memory 932 which is used to store instructions that may be executed by the processing component 922, such as application programs. The application programs stored in the memory 932 may include one or more modules, each of which corresponds to a set of instructions. In addition, the processing component 922 is configured to execute the instructions to perform any foregoing method that is applied to the base station.

The base station 900 may also include a power supply component 926 configured to perform power management for the base station 900, a wired or wireless network interface 950 configured to connect the base station 900 to a network, and an input/output (I/O) interface 958. The base station 900 may operate based on an operating system stored in the memory 932, such as Windows Server™, Mac OS X™, Unix™, Linux™, FreeBSD™ or the like.

Other implementations of the present disclosure will be readily apparent to those skilled in the art after implementing the disclosure by referring to the specification. The present disclosure is intended to cover any variations, uses, or adaptations of the present disclosure that are in accordance with the general principles thereof and include common general knowledge or conventional technical means in the art that are not disclosed in the present disclosure. The description and the examples are only illustrative, and the true scope and spirit of the present disclosure are set forth in the appended claims.

It is to be understood that the present disclosure is not limited to the above-described accurate structures illustrated in the drawings, and various modifications and changes can be made to the present disclosure without departing from the scope thereof. The scope of the present disclosure is to be limited only by the appended claims.

1. A charging correction method, performed by a radio access network (RAN) entity, the method comprising:
sending usage data information for a charging correction to a network function,
wherein the usage data information indicates packets dropped by the RAN entity in a packet data unit (PDU) set based quality of service (QoS) handling procedure, and
wherein the network function is a first network function or a second network function.

2. The method according to claim 1, wherein the first network function is a user plane function (UPF), and the second network function is a session management function (SMF).

3. The method according to claim 1, wherein the usage data information is used for the charging correction on a scheduled service, and the scheduled service comprises at least one of:
an extended reality and media (XRM) service; or
a multimodal service.

4. The method according to claim 1, wherein sending the usage data information for the charging correction to the network function comprises:
sending the usage data information to the network function at a level of predetermined usage data, wherein the predetermined usage data comprises at least one of:
usage data of a service data flow;
usage data of a QoS flow; or
usage data of a whole PDU session.

5. The method according to claim 4, further comprising:
collecting the usage data information at the level of the predetermined usage data.

6. The method according to claim 4, further comprising:
collecting the usage data information according to a monitoring key.

7. The method according to claim 1, further comprising at least one of:
determining that a PUD set is dropped, wherein a PDU set delay budget (PSDB) is exceeded;
determining that the PUD set is dropped, wherein a PDU set error rate is exceeded;
determining that the PUD set is dropped, wherein a delivery of one or more dependent PDU sets fails;
determining that the PUD set is dropped, wherein a delivery of one or more important PDU sets fails;
determining that a packet of the PDU set is dropped, wherein a packet error rate is exceeded;
determining that the packet of the PDU set is dropped, wherein a delivery of one or more dependent packets of the PDU set fails;
determining that the packet of the PDU set is dropped, wherein a delivery of one or more important packets of the PDU set fails; or
determining that the packet of the PDU set is dropped, wherein a packet delay budget is exceeded.

8. The method according to claim 1, wherein a charging scheme of a PDU set based charging comprises one of:
a usage charging scheme;
a usage-duration combined charging scheme;
a usage-event combined charging scheme; or
a usage-duration-event combined charging scheme.

9. The method according to claim 1, wherein a charging approach of a PDU set based charging comprises one of:
an online charging approach;
an offline charging approach; or
a hybrid online and offline charging approach.

10.-17. (canceled)

18. A charging correction method, performed by a second network function, the method comprising:
receiving usage data information for a charging correction sent by a radio access network (RAN) entity or a first network function,
wherein the usage data information indicates packets dropped by the RAN entity in a packet data unit (PDU) set based quality of service (QoS) handling procedure.

19. The method according to claim 18, wherein the first network function is a user plane function (UPF), and the second network function is a session management function (SMF).

20. The method according to claim 18, wherein the usage data information is used for the charging correction on a scheduled service, and the scheduled service comprises at least one of:
an extended reality and media (XRM) service; or
a multimodal service.

21. The method according to claim 18, wherein receiving the usage data information for the charging correction sent by the RAN entity or the first network function comprises:
receiving the usage data information sent by the RAN entity or the first network function at a level of predetermined usage data, wherein the predetermined usage data comprises at least one of:
usage data of a service data flow;
usage data of a QoS flow; or
usage data of a whole PDU session.

22. The method according to claim 18, further comprising:
determining a charging offset for the charging correction according to the usage data information.

23. The method according to claim 22, further comprising:
obtaining corrected usage data by correcting usage data to be charged according to the charging offset.

24. The method according to claim 23, further comprising:
sending information on the corrected usage data to a charging function (CHF).

25. The method according to claim 18, wherein a charging scheme of a PDU set based charging comprises one of:
a usage charging scheme;
a usage-duration combined charging scheme;
a usage-event combined charging scheme; or
a usage-duration-event combined charging scheme.

26. The method according to claim 18, wherein a charging approach of a PDU set based charging comprises one of:
an online charging approach;
an offline charging approach; or
a hybrid online and offline charging approach.

27.-31. (canceled)

32. A communication device, comprising:
one or more memories; and
one or more processors, connected to the one or more memories and configured to, by executing computer-executable instructions stored on the one or more memories, send usage data information for a charging correction to a network function, wherein the usage data information indicates packets dropped by a radio access network (RAN) entity in a packet data unit (PDU) set based quality of service (QoS) handling procedure, and wherein the network function is a first network function or a second network function.

33. (canceled)

34. A communication device, comprising:
one or more memories; and
one or more processors, connected to the one or more memories and configured to, by executing computer-executable instructions stored on the one or more memories, implement the method according to claim 18.
